(19) United States
(12) Patent Application Publication
(10) Pub. No.: US 2022/0219324 A1
(43) Pub. Date: Jul. 14, 2022

(54) SAFETY AND INTEGRITY VIOLATION DETECTION SYSTEM, DEVICE, AND METHOD

(71) Applicant: Intel Corporation, Santa Clara, CA (US)

(72) Inventors: Vinayak HONKOTE, Bangalore (IN); Rajesh POORNACHANDRAN, Portland, OR (US); Nikhilesh Kumar SINGH, Tamil Nadu (IN)

(21) Appl. No.: 17/709,493

(22) Filed: Mar. 31, 2022

(51) Int. Cl. B25J 9/16

(52) U.S. Cl. CPC B25J 9/1676; G05B 2219/50193; G05B 2219/39001; B25J 9/163

(57) ABSTRACT

A safety system includes a robot, the robot comprising, a function module, configured to perform a robot function; and

a safety module, configured to communicate with the robot, the safety module comprising a stimulus-response tester, configured to send a stimulus of a stimulus-response pair, comprising a stimulus and an expected response to the stimulus, to the robot for processing by the function module; and receive from the function module a response representing the processed stimulus; wherein if a difference between the response and the expected response is within a predetermined range, the safety module is configured to operate according to a first operational mode; and if the difference between the response and the expected response is outside of the predetermined range, the safety module is configured to operate according to a second operational mode.

### TECHNICAL FIELD

Various aspects of this disclose relate to methods and devices for detection of safety and/or integrity violations in robots.

### BACKGROUND

Robots and robotic systems are increasingly utilized in a variety of implementations such as, for example, industrial, manufacturing, logistics, healthcare, and services implementations. Such robots may operate in close proximity to humans, or may otherwise operate such that their performance may affect human safety or well-being. Furthermore, even where robotic system malfunctions do not directly affect human safety or well-being, such malfunctions may result in undesirable damage, delay, and/or expense.

These robot malfunctions may occur from any of a variety of causes, whether more benign and expected causes such as regular wear and tear, or more nefarious causes such as adversarial influences and/or fault insertions. The known safety methods for monitoring robotic systems with the goal of detecting such malfunctions tend to be reactive. Otherwise stated, they tend to first detect a malfunction that itself could cause impaired safety, or unwanted damage or expense.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts an intelligent agent;

FIG. 2 depicts a system overview for a robot system;

FIG. 3 depicts sending of a stimulus in a stimulus-response pair;

FIG. 4A depicts a modular diagram showing communication;

FIG. 4B depicts anomaly detector functioning, according to an aspect of the disclosure;

FIG. 4C depicts integrity preserver functioning, according to an aspect of the disclosure;

FIG. 5 depicts a flowchart for the anomaly detector and the integrity preserver;

FIG. 6 depicts a system architecture of individual autonomous agents with safety components;

FIG. 7 depicts the input and output of a safety database;

FIG. 8 depicts the virtual safety module according to an aspect of the disclosure;

FIG. 9 depicts a flowchart for a safety-cycle using reinforcement learning;

FIG. 10 shows steps used at the cloud server for a communications-cycle;

FIG. 11 depicts an abstraction of the reinforcement learning agent as a state machine;

FIG. 12 depicts an optional broadcast;

FIG. 13 depicts an optional implementation using a distributed-ledger-based confidence score computation;

FIG. 14 depicts a system diagram;

FIG. 15 depicts a safety system according to an aspect of the disclosure; and

FIG. 16 depicts a safety method.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

As described above, robots are commonly used in industrial settings to perform various tasks. Previous generations of robots performed predefined tasks without feedback from a perception sensor (e.g. without perceiving its environment or taking into account its perception of the environment, so-called “dumb robots”). As robot technology has advanced, robots are more commonly designed to perform one or more tasks while perceiving their environment or otherwise relying on sensor information for guidance in task performance. Such perception may extend beyond simple feedback loops and instead rely on intelligent systems, such as, for example, any of decision making, perception, navigation, or task management. Such robots may be referred to as intelligent agents or autonomous agents. An intelligent agent or autonomous agent may by understood as an object that perceives its environment and autonomously acts to perform one or more tasks based at least in part on data representing the intelligent agent's perception of the environment.

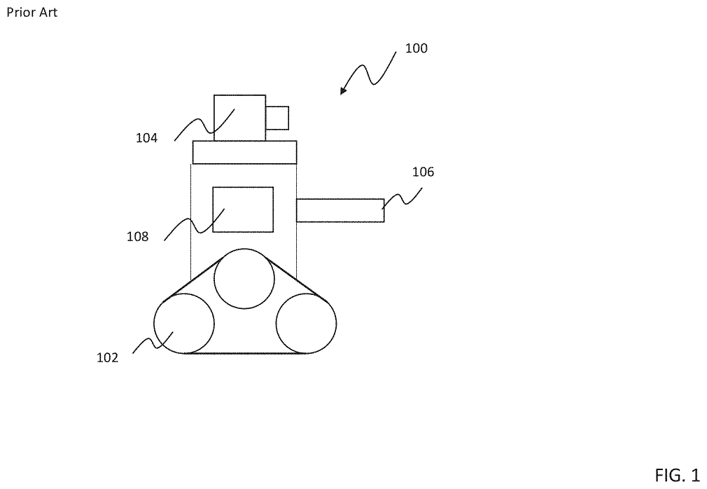

FIG. 1 depicts an intelligent agent 100 according to an aspect of the disclosure. The intelligent agent 100 may include one or more locomotion assemblies 102 for changing location or position. The locomotion assembly 102 may include one or more motors and one or more wheels or tracks or any other suitable device for moving from one position or location to another position or location. The intelligent agent 100 may include one or more perception modules 104. The one or more perception modules 104 may include one or more sensors for perceiving an aspect of the intelligent agent's environment, such as, for example, image sensors, Light Detection and Ranging Sensors (LIDAR), ultrasound sensors, temperature sensors, infrared sensors, accelerometers, inertial measurement unit sensors (IMUs), or any combination thereof. The one or more perception modules 104 may include one or more processors for processing the sensor data. The one or more perception modules may include one or more artificial neural networks, configured to receive sensor data and to output data based on the sensor data. The intelligent agent may further include one or more actuators 106, which may be configured to perform one or more tasks. Such tasks may include, for example, physical labor, such as lifting, moving, pushing, pulling, turning, rotating, or otherwise. Such actuators may be configured to perform high-level tasks such as welding, repairing, or otherwise. The intelligent agent may be configured to perform tasks with the actuators based at least in part on data from the one or more perception modules. The intelligent agent may further include one or more processing modules 108, which may employ one or more processors to perform various functions depending on the implementation, such as, for example, navigation, sensing, communication, testing, or otherwise. The term “robot” as used herein should be understood as a device that is capable of perceiving some aspect of its environment and taking an action based at least in part on its environmental perception. The term “robot” as used herein is intended to be synonymous with intelligent agent or autonomous agent. The term “robot system” may refer to a system including one or more robots and at least one additional computing entity, such as, for example, a server (e.g. an edge server, a cloud server, etc.).

As described above, known procedures for monitoring robots or robot system functions to detect safety or integrity violations are generally directed toward detecting a the existence of a malfunction that itself poses a danger to human safety or a likelihood of damage or expense. It would, however, be preferable monitor robots and robot systems to detect safety and integrity violations in real time. Such real-time detection may be able to uncover a safety or integrity violation before an action occurs that would otherwise result in monetary and/or human loss. In other words, it is desired to detect safety issue and then to determine an appropriate policy/action as a response. Furthermore, it is also desired to determine a confidence metric of one or more robots' capability of handling certain type of safety hazards proactively. Such determination may be performed with or without infrastructure collaboration, self-learning, and/or self-healing. This may allow a system to proactively take steps to improve safety and/or avoid a deterioration of safety.

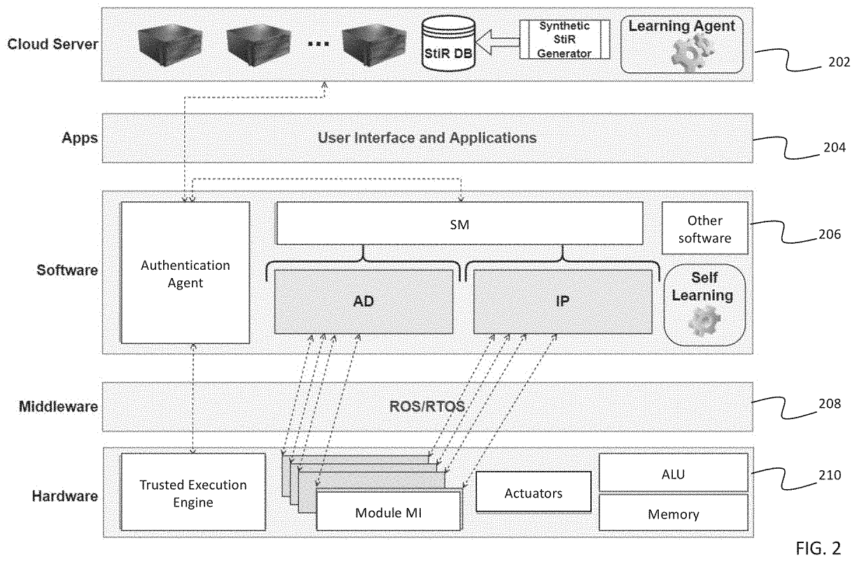

FIG. 2 depicts a system overview for a robot system, according to an aspect of the disclosure. The system may include at least one of a cloud server 202, which may include one or more processors; a stimulus-response (StiR) pair Database (labeled StiR DB), configured to store one or more stimulus-response pairs (e.g. StiR pairs); a StiR pair generator (also referred to herein as a StiR generator), configured to generate one or more stimulus-response pairs; or a learning agent, including one or more artificial neural networks, such as, for example, one or more reinforcement learning modules. The system may include a user interface and applications module 204, which may be configured to accept user input for one or more robot functions or application functions or routines, and/or to provide information to a user about one or more robot functions or application functions or routines. The system may include a server 206 (labeled in this figure as “software”), which may be configured as an edge server and which may be configured to send and receive data to and from the one or more robots. The server 206 may include at least one of an authentication agent, configured to authenticate one or more robots and/or one or more server modules; a safety manager, configured to perform one or more safety and/or integrity assessments on one or more robots; a secondary software module (labeled “other software”), configured to implement one or more other software functions according to the implementation; or an artificial neural network (labeled “self-learning”), configured to perform one or more machine learning functions as will be described in greater detail herein. The safety module may include an anomaly detector, configured to receive robot data and detect an anomaly within said data, as will be described in greater detail herein; an integrity preserver, configured to test robot integrity using stimulus-response pairs, as will be described in greater detail. The system may include a Robot Operating System (ROS) and/or a Real-Time Operating System (RTOS) 208. The ROS may be configured as a middleware suite that includes one or more software frameworks for robot operation. The RTOS may be an operating system for real-time applications. The system may include one or more robots 210, which may include a trusted execution engine, which may be configured to perform at least one of attesting to the authenticity of a platform and its operating system, assuring that an authentic operating system starts in a trusted environment, or providing a trusted operating system with additional security capabilities. Each robot may be configured with one or more modules, each module representing a function of the robot (e.g. perception, communication, navigation, actuator-related tasks, etc.). These modules may be referred to herein as “function modules”. The modules may be distinct, each module being configured to carry out a specific task. Alternatively, a single processor or group of processors may be configured to carry out the functions of a plurality of modules.

The robot system hardware portion 210 may further include at least one of a module management interface, which may be configured to receive data from and send data to the anomaly detector and the integrity preserver, as will be described in greater detail; one or more actuators; one or more processors, for example, one or more arithmetic-logic units; or one or more data storage modules (e.g. memories). That is, each robot may be configured to receive data from an anomaly detector (AD) and/or an integrity preserver (IP) and/or transfer data to the AD and/or IP as will be described in greater detail herein. Furthermore, the data from the AD and/or IP may be module specific, and therefore the module management interface may be configured to route data to the relevant module and may further be configured to receive data from the modules and route the data to the AD and/or IP.

The robot/robot system may employ a duplex federated learning failure stimulus-response characterization (StiR) methodology to detect safety and/or integrity violations. The StiR methodology may use one or more stimulus-response pairs, which are sent from the system (e.g. such as the edge server 206) to the robot for processing. The robot 210 responds with the response (e.g. a response to a command to process data according to the stimulus), and the integrity preserver evaluates the response to determine whether the response is within a predetermined range of expected response or outside of the predetermined range of expected response. Based on this determination, the server 206 or another aspect of the system, for example the server 202, may instruct the robot to operate according to either a first operational mode or a second operational mode.

As stated above, the system may include a synthetic StiR generator (e.g. a StiR generator or stimulus-response generator), which may be configured in the cloud server 202 but may alternatively be configured in a local server 206, such as an edge server. The Synthetic Stir Generator may be configured to generate a virtual stimulus for processing by one or more robots for evaluation of safety integrity. The system may track the activation profile of the robot's response to the stimuli and use this data to determine a confidence score, which may represent a degree of confidence in the robot's integrity. A learning agent (see 202) (alternatively or additionally 206) may use the confidence score in one or more machine learning operations. According to an aspect of the disclosure, message exchanges between the edge server, the cloud server, and/or the robot may be stimulus-response messages or non-stimulus-response messages. Stimulus-response messages may be denoted with a tag-bit, as will be explained in greater detail.

As stated above, the system may include a safety manager, which may be a standalone module or may be included in an existing module such as an existing safety module. The safety module may be configured to perform analysis and decision-making functions.

The safety module may include an Anomaly Detector (AD), which may be configured to log (e.g. constantly or periodically) behavioral features associated with a module M to detect anomalies. The time period between two outputs from the AD may be referred to as the AD-cycle. The anomaly detector may be configured to use one or more Machine Learning (ML) models on logged characteristic behavioral features in each component to detect anomalous behavior in a specific component. Depending on the task at hand, the AD logic can be rule-based or statistical in design. It may be configured to log features from the module which in case of the navigation control are actionable outputs of the module, such as torque, velocity, maneuvering angle; as well as internal features such as delays and temperature. The AD may be trained with mix of real-world data and a synthetic/digital twin of the robotic modules.

The safety manager may also include an IP, which may be configured to test the integrity of a Module M using a set of StiR pairs. The IP may check for functional correctness of M using a Scan-at-field approach. To infer correctness, the IP may send a robot/a module a set of stimuli, receive a corresponding response, and compare the corresponding response with a standard output response (e.g. an expected response). The IP may be configured to obtain a subset of the available stimulus-response pairs periodically for each component.

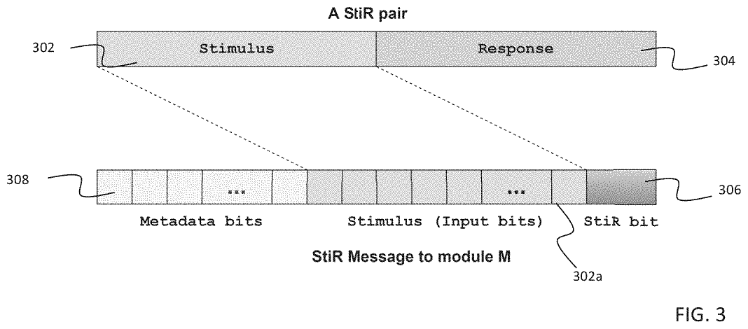

FIG. 3 depicts sending of a StiR stimulus according to an aspect of the disclosure. In this figure a StiR pair including a stimulus 302 and an expected response 304 is depicted. The system (e.g. the edge server, the cloud server, etc.) sends the stimulus 302 (see also 302a, depicting the stimulus in the context of a transmission to the robot) to the robot. The stimulus may be configured for processing within a particular module of the robot, such as, for example, a navigation module, a perception module, etc. In greater detail, the IP may select a set of StiR pairs and may forms StiR messages for sending to the module. The StiR message includes the stimulus, which is the actual operable input for M to process.

The communication of the StiR stimulus may also include a StiR-bit 306, which may be a bit that indicates to the robot (e.g. the robot module) that the communication is part of a Stir stimulus. In this manner, the StiR bit may denote the stimulus as a StiR message. For example, the StiR bit may be set to ‘1’ if the message is a StiR message; the StiR bit may be set to ‘0’ for a non-StiR message. The system may send the StiR message to the module, which generates a response based on the optional metadata and the input bits. The robot sends this response to the IP.

With this information, the robot (e.g. the robot module) may be configured to perform the requisite processing of the StiR stimulus, but not to physically act upon the StiR stimulus. This prevents interference with the robot's primary task. For example, the StiR stimulus may include instructions to navigate to a location, and the expected response would be instructions to control one or more actuators to move such that the robot travels to the location. In this example, the robot may deliver as the StiR-response the instructions to control the one or more actuators, but the robot may not actually control the actuators to move because the robot has identified that the stimulus is part of a StiR test based on the StiR-bit. As another example, the Stir-stimulus may include an image, such as an image that could be detected by the robot's image sensor, and the StiR-response could be data representing the image after being processed according to one or more image processing steps (e.g. converting the image to a different format, labeling data, introducing bounding boxes, etc.). In this example, the StiR-bit may cause the robot to process the image, but not to forward the processed image to the perception module for incorporation of the image data into the robot's model of its surroundings.

The IP may optionally be configured to add metadata 308 to aid in information transfer to M. An example of such metadata can be the status of input modules to M which can be important in sequential daisy-chained modules.

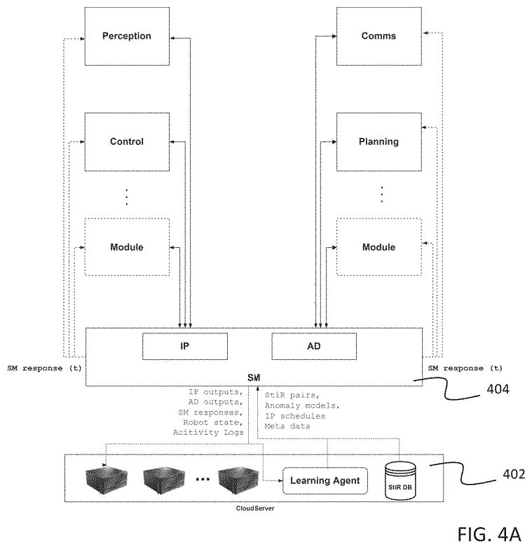

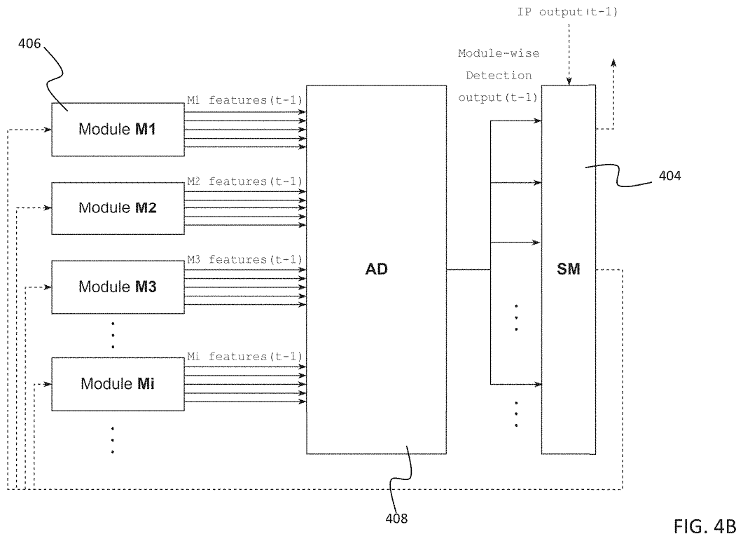

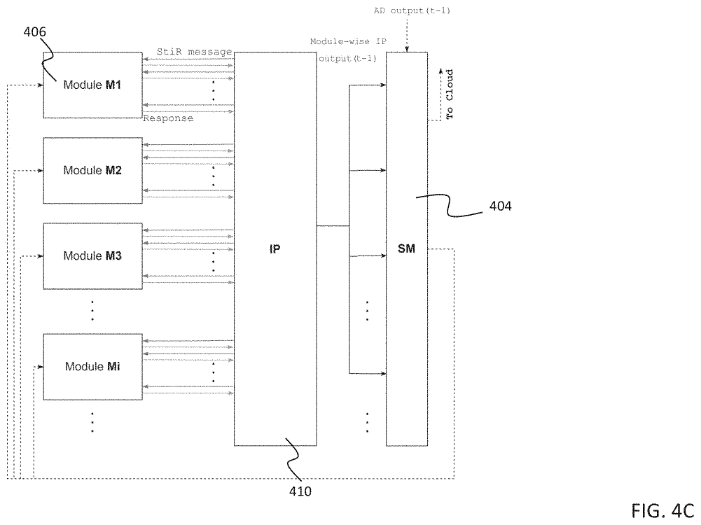

FIG. 4A depicts a modular diagram showing communication between the cloud server 402, the edge server 404 containing the safety module, and the various modules of a robot (depicted herein exemplarily as Perception, Control, Comms, Planning, and Module). In this figure, the cloud server 402 may send at least one of StiR pairs, anomaly models, IP schedules, or metadata to the edge server 404. The edge server 404 receives from the robot, and forwards to the cloud server, at least one of IP outputs, AD outputs, SM responses, robot states, or activity logs.

The IP may be configured to compare the received response to the expected response from the StiR pair to determine whether the expected response is within a predetermined range. If the response is within the predetermined range, the system may be configured to operate according to a first operational mode. If the response is outside of the predetermined range, the system may be configured to operate according to a second operational mode. The second operational mode may include the IP and/or server (e.g. the edge server, the cloud server, etc.) reporting an integrity violation to the central SM. The second operational mode may include taking one or more affected modules or one or more affected robots office. The second operational mode may include generating an instruction to remedy the safety or integrity violation and sending the instruction to the affected module and/or robot. In some configurations, the predetermined range may be configured to include a tolerance of deviation from the expected response to the StiR stimulus. In other configurations, the predetermined range may include only the expected response to the StiR stimulus. The IP may operate in OP-cycles, which may include sending a stimulus, receiving a corresponding response, comparing the received corresponding response to an expected response, and instructing the robot/the module to operate in a first operational mode or a second operational mode based on the comparison

The IP may be configured to operate in bursts, such as by being based on a non-interfering scheduling logic, referred to herein as an IP-cycle. The safety manager may be configured to use the AD and IP components to yield actionable decisions and perform two-way communications with the cloud server for the duplex federated-learning and general information updates.

The IP may be configured to attempt to avoid interfering with the robot's primary task by efficiently scheduling the integrity checks (e.g. the sending of the StiR stimulus) based on the activity profiles of each module. That is, the robot may be configured to send its activity logs to a sever (e.g. the edge server, the cloud server, etc.), and from the activity logs, the system may be configured to generate a prediction of when the robot will be performing its primary task. The IP may then be configured to only perform integrity checks when the module M is not predicted to be performing its primary task (e.g. not performing computations for its task).

FIG. 4B depicts an AD functioning in the t−1 AD cycle. In this figure, the modules (M1 is exemplarily referenced as 406) send data (e.g. M1 features) to the AD 408 at a period, t. Meanwhile, the AD 408 detects anomalies from its previously available data, which corresponds to data transferred at or before t, or otherwise corresponding to t−1. The AD 408 sends the SM 404 any anomalies detected from the data corresponding to t−1. In the next time period, t+1, the AD 408 detects anomalies from t. In this manner, the AD 408 updates the SM 404 based at least on data available from the previous transmission time.

FIG. 4C depicts the IP functioning in the t−1 AD cycle. In this figure, the IP 410 sends the modules (M1 is exemplarily referenced as 406) a StiR-stimulus at a period, t, and the modules (e.g. M1 406) send the StiR-response. Meanwhile, the IP 410 may compare a previously-received StiR-response (e.g. a response already available to the IP at time t, which may correspond to a StiR-stimulus sent at time t−1) and report to the SM whether the StiR-response is within the predetermined threshold and/or whether to operate according to the first operational mode or the second operational mode. In the next time period, t+1, the IP 410 evaluates the StiR-responses received from time t. In this manner, the IP 410 updates the SM 404 based at least on data available from the previous transmission time.

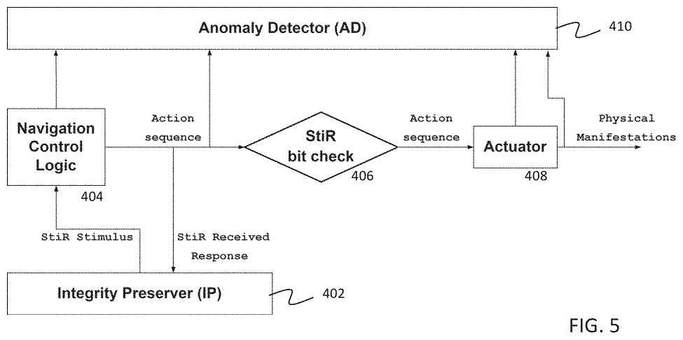

FIG. 5 depicts a flowchart for the anomaly detector and the integrity preserver as disclosed herein. In this example, the IP 402 sends a StiR stimulus to the navigation control logic 404 of the robot for processing. The navigation control logic 404 performs one or more actions on the StiR stimulus and sends the response to the IP 402 for evaluation as described herein. The robot may be configured to perform a StiR bit check 406, during which the robot will determine whether the action sequence output by the navigation control logic 404 results from a StiR stimulus and, if so, the action sequence will not b e forwarded on to the actuator 408. If the action sequence, however, does not result from a StiR stimulus (e.g. based on the StiR bit), the action sequence will be sent to the actuator 408 to be implemented. The AD 410 may receive input at any of these steps (e.g. from any of these elements), such as from the navigation control logic 404, the action sequence, the StiR bit check results 406, the actuator 408, or otherwise. The AD may be configured to detect an anomaly in any of these data and/or in any combination of these data.

The Safety Module (SM) may be understood as a central node for decision making based on the insights from AD and IP components from one or more robots. The SM may include at least one of the following task-capabilities/modules: intra-module anomaly, inter-module anomaly, integrity preservation, or two-way cloud communication and learning.

Regarding intra-module anomaly, the SM may be configured to receive output from the Anomaly Monitor, such as for one or more modules, and based on the output, the SM may be configured to send a signal to either continue or pause the module. The SM may perform this action separately for each module.

Regarding, inter-module anomaly, although most anomalous behavior is likely to be localized to a single module, it is also possible to observe anomalous behavior at multiple modules, whether occurring simultaneously or concurrently in multiple modules, or whether not independently detectable in a single module, but rather detectable using data from two or more modules. In one example, there can be a cascading failure across different sequential modules which would then necessitate the diagnosis of each module along the control path. In a second example, there can be a situation with two modules exhibiting non-anomalous behavior individually, but their results together turn out to be contradictory. An example can be of light sensors indicating satisfactory lighting conditions, but the imaging modules output picture of poor quality (e.g. fuzzy, blurry, etc.). This can imply an anomaly in either of the modules.

Regarding integrity Preservation, the SM may be configured to receive output from the IP, for example as a bitmap of the modules along with the StiR pair that failed.

Regarding two-way cloud communication and learning, and in addition to robot-specific functions, the SM may also be responsible for security communications with the cloud. The SM may be configured to receive the StiR pairs for different modules periodically to be deployed at the IP. The SM may be configured to send the StiR pairs found to be erroneous to the cloud server for learning. Further, the SM may be configured to send any local modifications, such as the addition of a peripheral module, to the cloud server. The cloud server may be configured to train StiR pairs.

The edge/cloud server may be configured to use information sent by the SM to actively learn the parameters in a duplex-federated manner. The Duplex-federated learning on the StiR pairs can be performed in multiple ways. In a first example, the cloud server can analyze the pattern based on the stimulus and any gap between the expected-response and the received response from a given module. Alternatively, the output of AD can be combined with the StiR observations to aid the learning models. In some implementations, the state of the module can also be considered to determine the response. Furthermore, for any given module, the module-state space may require storage in excess of what may be available in a local environment (e.g. for example in the edge server). To alleviate this issue, a golden copy of the robot may be stored at the cloud server for the comparison.

The server(s) may be configured to learn based on activity profiles of one or more modules. In this manner, the federated learning may begin with an empirically evaluated activity profile of one or more modules. This may permit the integrity checks (e.g. sending the StiR pairs) to be performed when a module is not otherwise occupied with its primary task. With a defined frequency for such testing (e.g. for the integrity checks), the SM may send the activity events of the modules to the cloud server, and may receive updates to the scheduling based on the recent changes in the activities.

The cloud server, for example based on the results from the previous responses from the module, may be configured to order the StiR pairs to be transmitted to the module IP. In some instances, this may be implemented, for example, using a Red-Black tree, with the left-most node being the best candidate to send as an input to a module. When using this implementation, the cloud server could have a Red-Black tree for each specific module in the robot.

Impact of addition of peripherals on anomalous behavior. Federated learning may often utilize a model of anomalous behavior for each module. However, there are instances in which peripherals may directly affect the behavior of certain modules. To address these instances, the SM may periodically send the state of the robot with respect to addition or removal of peripherals to the cloud server. The cloud server may use this information for training (e.g. offline training), which may be used in later deployments to prevent false positives.

The following discloses an exemplary federated learning StiR (FLStiR) implementation on navigational modules. That is, in this example, a navigation control module is used as an example for deployment of an FLSTiR scheme. The navigation control module takes as an input a path and outputs the motion action sequences to cover the given path. In this example, a path is given by a sequence of points in geometrical space. The motion actions include the directional actions such as left, right, up, down; or quantifiable inputs such as torque or angle.

In this manner, the StiR pair for navigation control may be:

| Stimulus | Response |
|---|---|
| A 3-dimensional path: | Sequence of actions: |
| <(x1, y1, z1), (x2, y2, z2), | <(left, 5 steps, 90 degrees), |
| (x3, y3, z3), . . . , (xn, yn, zn)> | (up, 5 steps, 12 degrees), . . .> |

Accordingly, the corresponding StiR message can be represented as:

| Metadata | Stimulus | StiR Bit |
|---|---|---|
| Bitmap representing status | Sequence of actions: | 1 |
| of daisy-chained modules: | <(x1, y1, z1), (x2, y2, z2), | |
| <c1, c2, c3, . . . , ck> | (x3, y3, z3), . . . , (xn, yn, zn)> | |

Regarding Virtual Sensing and Learning for Safety in Autonomous Agents (ViSLS), and given a networked robotic systems {R1, R2, R3, . . . , Rm}, each with a set of modules {M1, M2, M3, . . . , Mn} to perform a task T, it may be desired to detect: at least one of an unsafe behavior at Mi in each robot Rj; corrective measures to the actuator at Mi to bring Rj back to a safe state; or a mechanism to transfer learning from instances from any of the robots experience, while maintaining no functional interference to T for a robot R in safe state.

ViSLS may be configured to periodically assesses the safety of robot. This period for assessment may be referred to herein as the safety-cycle. Additionally, each robot may be configured to performs a two-way communication with the cloud server at specific intervals, which may be referred to herein as the comm-cycle.

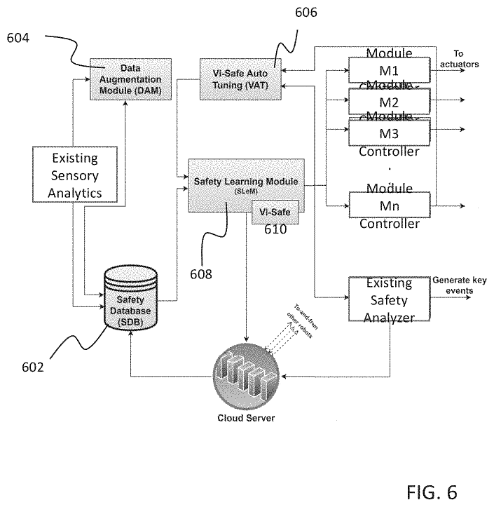

FIG. 6 depicts a system architecture of individual autonomous agents with proposed ViSLS components. The ViSLS may include a Safety Database (SDB) 602, which may be understood as a central safety log storage for the robotic system. The SDB may be configured to store data from any existing sensory analytics (e.g. legacy analytics, known analytics) available in the design along a virtual sensor Vi-Safe module output. This may form a dataset with sensor logs and Vi-Safe action pairs, which may then be forwarded to the Safety Learning Module 606.

The ViSLS may include a Safety Learning Module (SLeM) 608. The SLeM may be configured to receive inputs from the VAT 606 and entries from the Safety Database 602. It may generate control actions for various modules while sharing them to any existing safety analyzers on the robotic systems.

The SLeM may include a Virtual Safety Sensor (Vi-Safe) 610, which may be configured to output a sequence of corrective actions. These corrective actions may be based on at least one of post-augmentation data originating from the physical sensor from DAM; insights from the cloud, stored in the SDB, or feedback from the VAT module. Based on these inputs, the Vi-Safe 610 may propagate the corrective steps messages to the controller components, which, in turn, send it to the corresponding actuators.

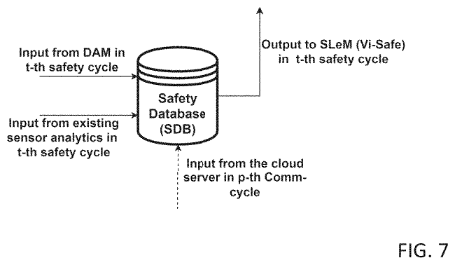

FIG. 7 depicts the input and output of the SDB, according to an aspect of the disclosure. In this configuration, the SDB 602 primarily stores data received from the existing sensory analytics available in the design along virtual sensor Vi-Safe module output, data received from the DAM, and data received from the cloud server. The SBD may be configured to output to the SLeM Vi-Safe module.

Sample actions in the SDB may include, but are not limited to, the robots' response to changes in speed/acceleration; response to occlusions including dynamic obstacles/other agents; parameters contributing to the operation such as, control logic/actuation control/number of degrees of freedom on a robotic arm etc.; or the response of robots during experimentation. These safety procedures may be configured so as not to interfere with the robots' normal operation of the robot. For example, if the current state is flagged as ‘unsafe’ then the operation is paused, and the state is saved. Meanwhile, in the background, corrective measures can be taken. For example, a flag can ‘flip’ based on the safe/unsafe event, and the robot may be configured to read this flag continuously to resume normal operation.

The ViSLS may include a Data Augmentation Module (DAM) 604. Physical sensors in the robots can log data related to the state and the activities of the robot in a given environment; however, such sensors have various physical design limitations that limit the resulting data. For example, a photography module is unable to provide more than a deterministic number of frames per second. Additionally, each robot can only receive data from its own sensors. The DAM 604 may provide solutions for these issues by collecting data from some or all of the local physical sensors in the robot; receiving identification of data outlies based on robot logs that are sent to the cloud; and with the observed data collected, the DAM may be configured to apply standard algorithms to augment the existing dataset, which may be helpful in enabling continuous transfer learning.

The ViSLS may include a Vi-Safe Auto Tuning module (VAT) 606, which may be configured to perform Reinforcement Learning (RL) based while analyzing a current state of the robot and, if found unsafe by the VAT 606, may be configured to provide corresponding corrections and messaging to the controller. The VAT 606 may be understood as a corrective feedback engine for SLeM outputs. The VAT 606 may be implemented as an active Reinforcement Learning (RL) agent that uses the state-action pairs to evaluate Vi-Safe outputs at various robot states. The RL agent may work with a state-action-reward cycle. An example of these parameters may be as follows:

The state of the robot. As an example, the state will be considered to be the physical location of the robot. The action represents the set choices that the robot has that can potentially modify the state. More specific to this example, the set of sections is the set of navigational options available to the robot. The reward may be a configurable function for each State-action set definition. An example at reward cycle t may be:

R(t)=f(S(t),S(t−1)) (1)

Where, S(t) is the robot state in the t-th cycle and f( ) is a user designed reward function. An example for f( ) can be the following:

$$f ( S ( t ) , S ( t - 1 ) ) = \{ \begin{matrix}Highly negative , if S ( t - 1 ) ∈ safe set and S ( t ) ∉ safe set \\ Positive , if S ( t - 1 ) ∉ safe set and S ( t ) ∈ safe set \\ Zero or Slightly negative , otherwise\end{matrix} \qquad ( 2 )$$

where the safe set is the range of states deemed safe for the robot. The initial set may be given by the user and then learned and enhanced.

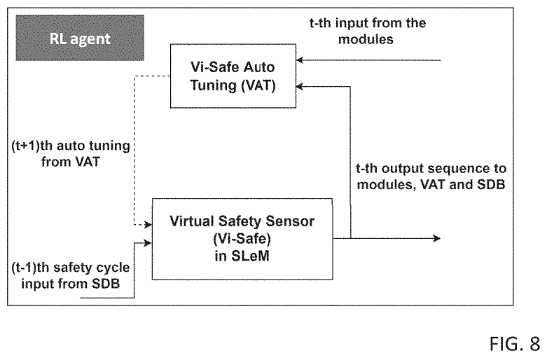

FIG. 8 depicts the Vi-Safe module according to an aspect of the disclosure. In this depiction, the Vi-Safe module is configured to receive safety cycle input from the SDB and data from the VAT, and it is configured to output sequences to the VAT and SBD modules.

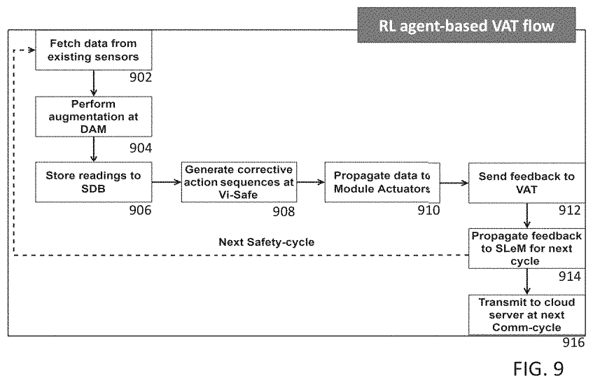

FIG. 9 depicts a flowchart of steps followed at the robot-end for a safety-cycle using RL. In a first safety-cycle, the ViSLS is configured to fetch data from existing sensors 902; perform augmentation at the DAM 904; store readings to the SDB; generate corrective action sequences at the Vi-Safe 908; propagate data to the module actuators 910; send feedback to the VAT 912; and propagate feedback to the SLeM for the next cycle 914. The ViSYS also transmits the feedback to the cloud server at the next comm-cycle 916.

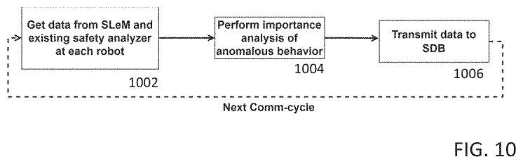

FIG. 10 shows steps used at the cloud server for a comm-cycle. The cloud server is configured to obtain data from the SLeM and any existing safety analyzer at each robot 1002; perform an importance analysis of anomalous behavior 1004; and transmit data to the SDB 1006.

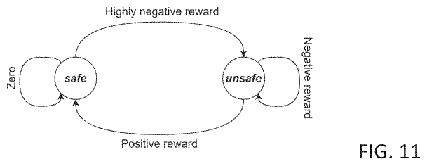

FIG. 11 depicts an abstraction of the reinforcement learning agent as a state machine. In this abstraction, the reinforcement learning agent includes a safe state and an unsafe state. When the machine is in the safe state, a positive reward or a neutral reward (e.g. zero) will result in the machine maintaining the safe state. When in the safe state, a highly negative reward will transfer the machine to the unsafe state. When in the unsafe state, a negative reward or a highly negative reward will cause the machine to maintain the safe state. A positive reward, however, will shift the machine into the safe state.

One noteworthy aspect of networked robotic systems is variance in the experiences logged at each robot node. ViSLS provides a mechanism for the transfer of this knowledge for effective safety guarantees. As shown in FIG. 6, one or more robots may log sensor data and the corrective responses to be transmitted to the cloud server. Upon analysis, the cloud servers may nominate the most important data points to be transferred to all the robots sharing the same environment. In the upcoming Comm-cycle, the datapoints are transmitted to the SDB of each robot. Upon encountering a severe outlier, a robot node may optionally save time by broadcasting the datapoints to each the robots in the shared environment while the transmission to the cloud continues. This may be advantageous as it permits the robots in the same environment to make use of the critical datapoints in the next Safety-cycle right away, compared to the next Comm-cycle which is further away in time. Additionally, in the next Comm-Cycle, the cloud performs is usual transmissions, which can also cater to the robot nodes outside the shared environment.

The data may be generated with the existing physical sensors in the robots and the virtual safety sensor. For example, if it is determined that in the present environment navigation is not a safety concern (e.g. in a physically caged environment), then the ViSLS need not consider the navigational sensors for safety analysis. Such pruning of sensor data may be performed before storing the information in the safety database.

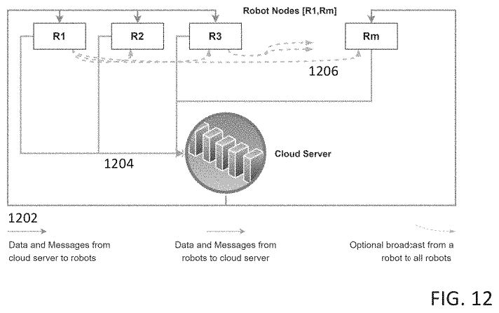

FIG. 12 depicts this optional broadcast as described above. In this figure, the cloud server sends data messages 1202 to each of the robots R1, R2, R3 . . . Rm. Each of the robots may send data 1204 to the cloud server. The cloud server may then send some or all of this received data to the robots in the next comm-cycle. As an optional method of data transmission, any or all of the robots may broadcast 1206 data and/or messages to the other robots. This broadcast data may include any or all of the data that would otherwise be sent to the cloud server. By broadcasting the data rather than sending the data to the cloud server, the other robots may obtain the broadcast data before the next comm-cycle, at which time the data would normally be transmitted from the cloud server to the various robots.

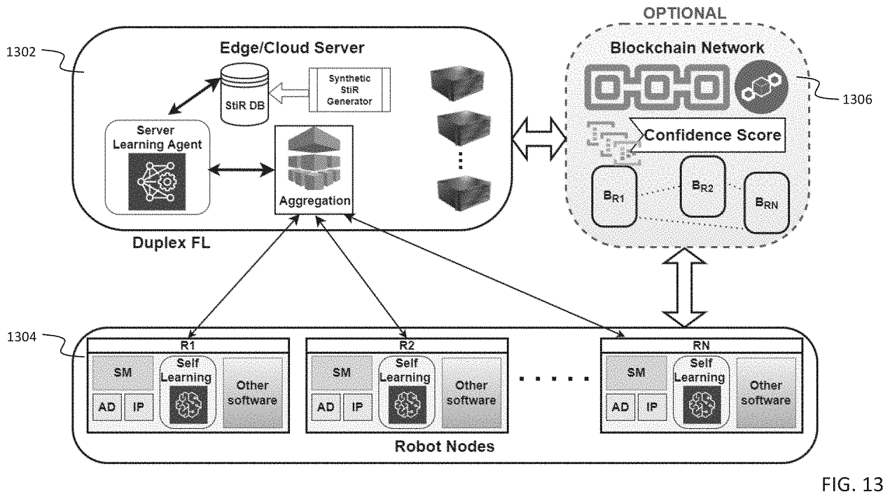

Regarding FLStiR Architecture with Blockchain based confidence score tracking, FIG. 13 depicts an optional implementation, in which Duplex federated learning is performed with a distributed-ledger-based confidence score computation. In this implementation, the robots (depicted generally as 1304) act as blockchain miners. The safety information from individual nodes forms the basis of transactions. These transactions are validated against the learned safety scores to compute and track a confidence score, which could be further used to enhance safety learning and validation. In this way, the distributed ledger provides the capability for secure anonymous audit trails. This may be of particular use when the robots come from a plurality of manufacturers. In this manner, the distributed ledger is leveraged to track confidence/reputation score/audit trails for future audit trails, and to enhance safety learning and validation. With respect to the elements of FIG. 13, the various robots 1304 transmit their measurements as transactions, which are mined and saved within the blockchain network 1306. This blockchain 1306 is sent between the robot nodes 1304 and the server(s) (e.g. the edge server and/or the cloud server).

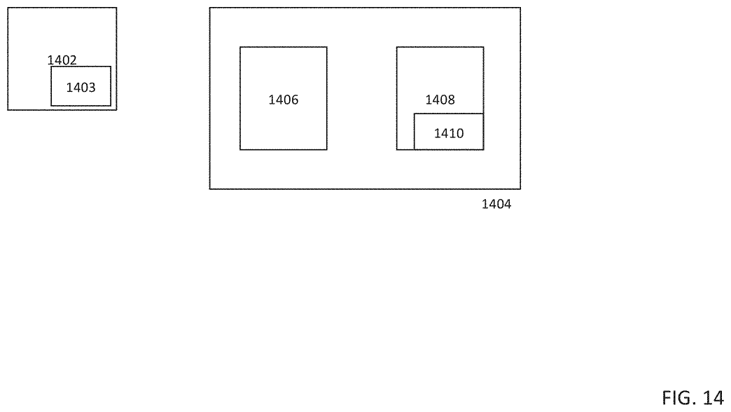

FIG. 14 depicts a safety system, including a robot 1402, configured to communicate with a safety module 1402, the robot including, a function module 1403, configured to perform a robot function; and a safety module 1404, including a stimulus-response tester 1406, configured to send a stimulus of a stimulus-response pair, including a stimulus and an expected response to the stimulus, to the robot 1402 for processing by the function module 1403; and receive from the function module 1403 a response representing the processed stimulus; wherein if a difference between the response and the expected response is within a predetermined range, the safety module is configured to operate according to a first operational mode; and if the difference between the response and the expected response is outside of the predetermined range, the safety module is configured to operate according to a second operational mode. The safety system may further include an anomaly detector 1408, the anomaly detector including an anomaly detector processor 1410, configured to receive anomaly detector input, representing an output of the function module, and to detect an anomaly in the anomaly detector input; wherein if the anomaly detector 1408 detects no anomaly, the safety module 1404 is configured to operate according to the first operational mode; and 1408 if the anomaly detector detects an anomaly, the safety module 1404 is configured to operate according to the second operational mode.

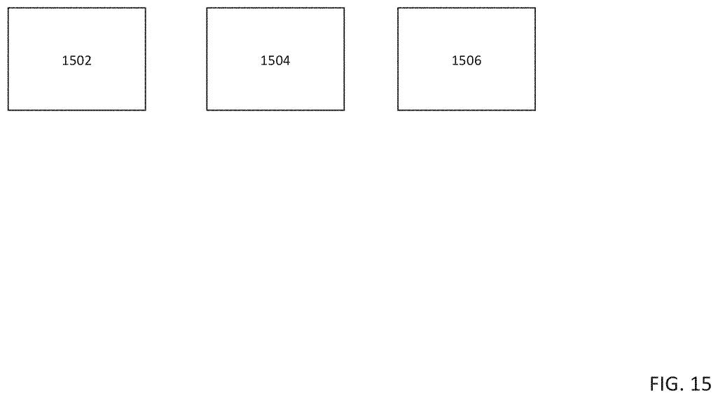

FIG. 15 depicts a safety system, including a data augmentation module 1502, configured to receive operational data from one or more sources, the operational data representing operations of a robot and including at least sensor data from one or more sensors of the robot; and augment the sensor data according to one or more data augmentation techniques; and a virtual sensor 1504, configured to, determine based on at least the augmented data, a safety factor for the robot; wherein if the safety factor is within a predetermined range, operate according to a first operational mode; and wherein if the safety factor is outside of the predetermined range, operate according to a second operational mode; wherein operating according to the second operational mode includes determining a corrective action for the robot and sending a signal representing an instruction to perform the corrective action to the robot. The safety system may further include a data tuner 1506, configured to execute one or more recurrent learning procedures using the signal representing the instruction to the robot to perform the corrective action and data representing one or more outputs of the robot.

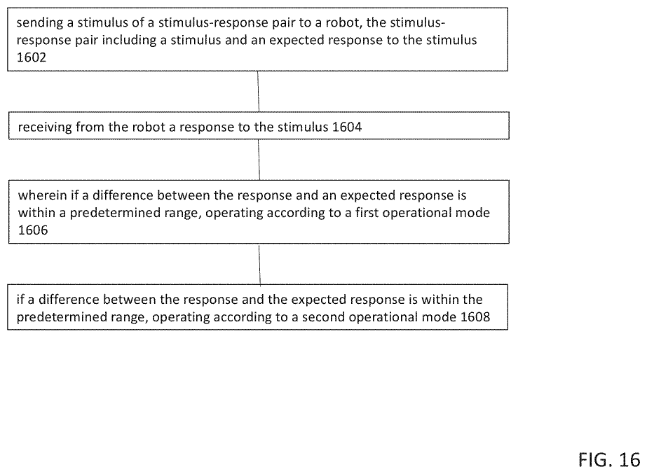

FIG. 16 depicts a safety method including sending a stimulus of a stimulus-response pair to a robot, the stimulus-response pair including a stimulus and an expected response to the stimulus 1602; receiving from the robot a response to the stimulus 1604; wherein if a difference between the response and an expected response is within a predetermined range, operating according to a first operational mode 1606; and if the difference between the response and the expected response is outside of the predetermined range, operating according to a second operational mode 1608.

Although this disclosure describes its systems, devices, methods, and underlying principles in terms of safety, these concepts can readily be applied to other aspects of robot management that are not directly related to safety. For example within a fleet of robots, the “safety module” can be used to detect any undesirable behavior, even if such behavior is not directly relevant to safety. For example, any one robot may process data (e.g. images, sensor data, etc.), locomote, perform module tasks, or otherwise such that these are performed undesirably or suboptimally, even when such tasks do not necessarily pose a safety hazard. The safety manager as disclosed herein my detect this undesirable behavior and correct this behavior using the principles described herein with respect to safety.

Additional aspects of the disclosure will be provided below by way of Example:

In Example 1, a safety system, including: a robot, including, a function module, configured to perform a robot function; and a safety module, configured to communicate with the robot, the safety module including a stimulus-response tester, configured to: send a stimulus of a stimulus-response pair, including a stimulus and an expected response to the stimulus, to the robot for processing by the function module; and receive from the function module a response representing the processed stimulus; wherein if a difference between the response and the expected response is within a predetermined range, the safety module is configured to operate according to a first operational mode; and if the difference between the response and the expected response is outside of the predetermined range, the safety module is configured to operate according to a second operational mode.

In Example 2, the safety system of Example 1, wherein the safety module is configured to determine the difference between the response and the expected response.

In Example 3, the safety system of Example 1 or 2, wherein sending the stimulus to the robot includes sending an instruction including one or more instruction bits representing the stimulus, and one or more stimulus identification bits, the stimulus identification bits indicating that the instruction bits are a stimulus for stimulus-response testing.

In Example 4, the safety system of Example 3, wherein the robot is configured to recognize the one or more stimulus identification bits, and in response to the one or more stimulus identification bits, disable one or more actuators such that the stimulus is not physically performed.

In Example 5, the safety system of any one of Examples 2 to 4, wherein the stimulus-response tester is further configured to send a stimulus to the robot according to a stimulus-response testing schedule, wherein the stimulus-response testing schedule represents predicted periods of inactivity of the function module.

In Example 6, the safety system of any one of Examples 2 to 5, wherein the difference between the response and the expected response is a confidence score of the response, and wherein the safety module is further configured to determine the confidence score.

In Example 7, the safety system of any one of Examples 2 to 6, wherein the stimulus-response tester is further configured to generate a fitness assessment of the robot using a scan-at-field procedure.

In Example 8, the safety system of any one of Examples 1 to 7, wherein the safety module further includes an anomaly detector, including: an anomaly detector processor, configured to receive anomaly detector input, representing an output of the function module, and to detect an anomaly in the anomaly detector input; wherein if the anomaly detector detects no anomaly, the safety module is configured to operate according to the first operational mode; and if the anomaly detector detects an anomaly, the safety module is configured to operate according to the second operational mode.

In Example 9, the safety system of Example 8, wherein the safety module is an edge server.

In Example 10, the safety system of Example 8 or 9, wherein the function module is a first function module, and wherein the robot further includes a second function module; and wherein the anomaly detector processor is configured to receive anomaly detector input, representing an output of the first function module and the second function module, and to detect an anomaly in the anomaly detector input; wherein if the anomaly detector detects no anomaly, the safety module is configured to operate according to the first operational mode; and if the anomaly detector detects an anomaly, the safety module is configured to operate according to the second operational mode.

In Example 11, the safety system of any one of Examples 8 to 10, wherein the robot is a first robot and the function module of the first robot is a first function module, and wherein the safety system further includes a second robot; wherein the second robot includes a second function module; and wherein the anomaly detector processor is configured to receive anomaly detector input, representing an output of the first function module and an output of the second function module, and to detect an anomaly in the anomaly detector input; wherein if the anomaly detector detects no anomaly, the safety module is configured to operate according to the first operational mode; and if the anomaly detector detects an anomaly, the safety module is configured to operate according to the second operational mode.

In Example 12, the safety system of any one of Examples 8 to 11, wherein the artificial neural network is configured to detect the anomaly according to a predetermined schedule.

In Example 13, the safety system of any one of Examples 8 to 12, wherein the anomaly detector processor is configured to detect the anomaly by implementing one or more rule-based operations.

In Example 14, the safety system of any one of Examples 8 to 13, wherein the anomaly detector further includes an artificial neural network, and wherein the anomaly detector processor is configured to detect the anomaly by implementing the artificial neural network.

In Example 15, the safety system of any one of Examples 8 to 14, wherein the output of the function module includes one or more control outputs of the function module.

In Example 16, the safety system of Example 15, wherein the one or more control outputs of the function module include at least one of a processing delay of the robot, a temperature of a component of the robot, an image sensor output of the robot, an image processing output of the robot, a distance measured using a proximity sensor, a light intensity using a light sensor, a volume measured using a microphone, or a velocity or acceleration measured using a sensor of the robot.

In Example 17, the safety system of any one of Examples 8 to 16, wherein the output of the function module includes one or more navigation outputs of the function module.

In Example 18, the safety system of Example 17, wherein the one or more navigation outputs of the function module include at least one of a torque of an actuator of the robot, a velocity of the robot, an acceleration of the robot, an angle of movement of the robot compared to a reference point, or a position of the robot.

In Example 19, the safety system of any one of Examples 1 to 18, wherein the safety module is configured to operate according to the first operational mode if the difference between the response and the expected response is within the predetermined range, and if the anomaly detector detects no anomaly.

In Example 20, the safety system of Example 19, wherein the safety module is configured to operate according to second operational mode if the difference between the response and the expected response is outside the predetermined range, or if the anomaly detector detects no anomaly.

In Example 21, the safety system of any one of Examples 1 to 20, wherein the safety system further includes a server, configured to receive data from, and to send data to, the safety module.

In Example 22, the safety system of Example 21, wherein the server includes a stimulus-response library, the stimulus-response library including a plurality of stimulus-response pairs for the stimulus-response tester; wherein the server is configured to select one or more of the stimulus-response pairs for testing by the stimulus-response tester; and wherein the server is configured to send the selected one or more of the stimulus-response pairs to the safety module.

In Example 23, the safety system of Example 21 or 22, wherein the robot is configured to send an activity log to the safety module, the activity log representing past activities of the function module; wherein safety module is configured to send activity information representing the one or more activity logs to the server; wherein the server includes a predictive scheduler, the predictive schedule being configured to generate the stimulus-response testing schedule, wherein the stimulus-response testing schedule represents predicted periods of inactivity of the function module based on the activity information.

In Example 24, the safety system of any one of Examples 21 to 23, wherein the robot is a first robot and the function module of the first robot is a first function module, and wherein the safety system further includes a second robot; wherein the second robot includes a second function module; and wherein the server is configured to receive data representing a data output of the first function module and an output of the second function module, and wherein the sever is configured to perform a federated learning operation using the data representing the data output of the first function module and the output of the second function module.

In Example 25, the safety system of any one of Examples 21 to 24, wherein the safety module is a first safety module; wherein the safety system further includes a second safety module; and wherein the server is configured to receive data representing a data output of the safety module and an output of the second safety module, and wherein the sever is configured to perform a federated learning operation using the data representing the data output of the first safety module and the output of the second safety module.

In Example 26, the safety system of any one of Examples 21 to 25, wherein, operating according to the second operational mode further includes sending the stimulus and/or the response to the server; wherein the server further includes an artificial neural network, configured to perform a machine learning operation using the stimulus and/or the response.

In Example 27, the safety system of any one of Examples 21 to 26, wherein, operating according to the second operational mode further includes the server generating a virtual stimulus that is sent to one or more robots; receiving a response to the virtual stimulus, and generating a confidence score based on the response.

In Example 28, the safety system of any one of Examples 21 to 27, wherein the safety module is configured to send the response to the server, and wherein the server is configured to determine the difference between the response and the expected response.

In Example 29, the safety system of any one of Examples 1 to 28, wherein at least one of the response representing the processed stimulus received from the function module, the stimulus sent by the stimulus-response tester to the robot for processing by the function module; the anomaly detector input received by the anomaly detector processor from the function module; the one or more of the stimulus-response pairs sent from the server to the safety module; or the activity log sent from the robot to the safety module are encoded as part of a distributed public ledger.

In Example 30, the safety system of Example 29, wherein the distributed public ledger is a blockchain.

In Example 31, the safety system of any one of Examples 1 to 30, wherein the robot is a first robot; further including a second robot; and wherein the first robot is configured to transmit a message to the second robot.

In Example 32, the safety system of Example 31, wherein the message represents anomalous data detected by the first robot.

In Example 33, the safety system of Example 31 or 32, wherein the transmission of the message is a broadcast of the message.

In Example 34, the safety system of any one of Examples 1 to 33, further including a safety learning module, wherein the safety learning module is configured to receive safety data representing at least one of sensor data of one or more robots, data information from a server, or information from the tuning module and based on the safety data, generate and send a corrective action for implementation in one or more robots.

In Example 35, the safety system of Example 34, wherein the safety learning module is configured to generate the corrective action using reinforcement learning.

In Example 36, a safety system, including: a data augmentation module, configured to: receive operational data from one or more sources, the operational data representing operations of a robot and including at least sensor data from one or more sensors of the robot; and augment the sensor data according to one or more data augmentation techniques; and a virtual sensor, configured to determine a safety factor for the robot based on at least the augmented data; and if the safety factor is within a predetermined range, operate according to a first operational mode; and if the safety factor is outside of the predetermined range, operate according to a second operational mode; wherein operating according to the second operational mode includes determining a corrective action for the robot; and send a signal representing an instruction to perform the corrective action to the robot.

In Example 37, the safety system of Example 36, wherein the data augmentation module is further configured to receive operational log data, representing actions of one or more robots; and wherein the data augmentation module is further configured to augment the operational log data; wherein the operational data includes the augmented operational log data.

In Example 38, the safety system of any one of Examples 36 to 37, further including data tuner, configured to execute one or more recurrent learning procedures using the signal representing the instruction to the robot to perform the corrective action and data representing one or more outputs of the robot.

In Example 39, the safety system of Example 38, wherein the instruction to perform the corrective action is an instruction at a first time period, and wherein the data representing one or more outputs of the robot is from a second time period, after the first time period.

In Example 40, the safety system of Example 39, wherein the virtual sensor is configured to determine based on the data of the first time period and the second time period whether the instruction resulted in an increased safety factor.

In Example 41, the safety system of any one of Examples 38 to 40, wherein the executing the one or more recurrent learning procedures includes executing a reward function.

In Example 42, the safety system of any one of Examples 38 to 41, wherein the data tuner is further configured to determine a subset of sensor data from the robot and wherein the data tuner executing the one or more recurrent learning procedures includes executing the one or more recurrent learning procedures based on the subset of data.

In Example 43, a safety system including the elements of any of Examples 1 to 35 and the elements of any one of Examples 36 to 43.

In Example 44, a safety method, including: sending a stimulus of a stimulus-response pair to a robot, the stimulus-response pair including a stimulus and an expected response to the stimulus; receiving from the robot a response to the stimulus; wherein if a difference between the response and an expected response is within a predetermined range, operating according to a first operational mode; and if the difference between the response and the expected response is outside of the predetermined range, operating according to a second operational mode.

In Example 45, the method of Example 44, further including determining the difference between the response and the expected response.

In Example 46, the method of Example 44 or 45, wherein sending the stimulus includes sending an instruction including one or more instruction bits representing the stimulus, and one or more stimulus identification bits, the stimulus identification bits indicating that the instruction bits are a stimulus for stimulus-response testing.

In Example 47, the method of Example 46, wherein the robot is configured to recognize the one or more stimulus identification bits, and in response to the one or more stimulus identification bits, disable one or more actuators such that the stimulus is not physically performed.

In Example 48, the method of any one of Examples 45 to 47, further including sending a stimulus to the robot according to a stimulus-response testing schedule, wherein the stimulus-response testing schedule represents predicted periods of inactivity of the function module.

In Example 49, the method of any one of Examples 45 to 48, wherein the difference between the response and the expected response is a confidence score of the response, and further including determining the confidence score.

In Example 50, the method of any one of Examples 44 to 49, further including: receiving anomaly detector input representing an output of a robot, and detecting an anomaly in the anomaly detector input; wherein if the anomaly detector detects no anomaly, the safety module is configured to operate according to the first operational mode; and if the anomaly detector detects an anomaly, the safety module is configured to operate according to the second operational mode.

In Example 51, a safety system, including: a data augmentation module, configured to: receive operational data from one or more sources, the operational data representing operations of a robot and including at least sensor data from one or more sensors of the robot; and augment the sensor data according to one or more data augmentation techniques; and a virtual sensor, configured to determine a safety factor for the robot based on at least the augmented data; if the safety factor is within a predetermined range, operate according to a first operational mode; and if the safety factor is outside of the predetermined range, operate according to a second operational mode; wherein operating according to the second operational mode includes determining a corrective action for the robot; and send a signal representing an instruction to perform the corrective action to the robot.

In Example 52, the safety system of Example 51, wherein the data augmentation module is further configured to receive operational log data, representing actions of one or more robots; and wherein the data augmentation module is further configured to augment the operational log data; wherein the operational data includes the augmented operational log data.

In Example 53, the safety system of any one of Examples 51 to 52, further including data tuner, configured to execute one or more recurrent learning procedures using the signal representing the instruction to the robot to perform the corrective action and data representing one or more outputs of the robot.

In Example 54, the safety system of Example 53, wherein the instruction to perform the corrective action is an instruction at a first time period, and wherein the data representing one or more outputs of the robot is from a second time period, after the first time period.

In Example 55, the safety system of Example 54, wherein the virtual sensor is configured to determine based on the data of the first time period and the second time period whether the instruction resulted in an increased safety factor.

In Example 56, the safety system of any one of Examples 53 to 55, wherein the executing the one or more recurrent learning procedures includes executing a reward function.

In Example 57, a safety device, including: a safety module, including: a stimulus-response tester, configured to send a stimulus of a stimulus-response pair, including a stimulus and an expected response to the stimulus, to a robot for processing by the function module; and receive from the function module a response representing the processed stimulus; wherein if a difference between the response and the expected response is within a predetermined range, the safety module is configured to operate according to a first operational mode; and if the difference between the response and the expected response is outside of the predetermined range, the safety module is configured to operate according to a second operational mode.

In Example 58, the safety device of Example 57, wherein the safety module is configured to determine the difference between the response and the expected response.

In Example 59, the safety device of Example 57 or 58, wherein sending the stimulus to the robot includes sending an instruction including one or more instruction bits representing the stimulus, and one or more stimulus identification bits, the stimulus identification bits indicating that the instruction bits are a stimulus for stimulus-response testing.

In Example 60, the safety device of Example 59, wherein the robot is configured to recognize the one or more stimulus identification bits, and in response to the one or more stimulus identification bits, disable one or more actuators such that the stimulus is not physically performed.

In Example 61, the safety device of any one of Examples 58 to 60, wherein the stimulus-response tester is further configured to send a stimulus to the robot according to a stimulus-response testing schedule, wherein the stimulus-response testing schedule represents predicted periods of inactivity of the function module.

In Example 62, the safety device of any one of Examples 58 to 61, wherein the difference between the response and the expected response is a confidence score of the response, and wherein the safety module is further configured to determine the confidence score.

In Example 63, the safety device of any one of Examples 58 to 62, wherein the stimulus-response tester is further configured to generate a fitness assessment of the robot using a scan-at-field procedure.

In Example 64, the safety device of any one of Examples 57 to 63, wherein the safety module further includes an anomaly detector, including: an anomaly detector processor, configured to receive anomaly detector input, representing an output of the function module, and to detect an anomaly in the anomaly detector input; wherein if the anomaly detector detects no anomaly, the safety module is configured to operate according to the first operational mode; and if the anomaly detector detects an anomaly, the safety module is configured to operate according to the second operational mode.

In Example 65, the safety device of Example 64, wherein the safety module is an edge server.

In Example 66, the safety device of Example 64 or 65, wherein the function module is a first function module, and wherein the robot further includes a second function module; and wherein the anomaly detector processor is configured to receive anomaly detector input, representing an output of the first function module and the second function module, and to detect an anomaly in the anomaly detector input; wherein if the anomaly detector detects no anomaly, the safety module is configured to operate according to the first operational mode; and if the anomaly detector detects an anomaly, the safety module is configured to operate according to the second operational mode.

In Example 67, the safety device of any one of Examples 64 to 66, wherein the robot is a first robot and the function module of the first robot is a first function module, wherein the anomaly detector processor is configured to receive anomaly detector input, representing an output of the first function module and an output of a second function module of a second robot, and to detect an anomaly in the anomaly detector input; wherein if the anomaly detector detects no anomaly, the safety module is configured to operate according to the first operational mode; and if the anomaly detector detects an anomaly, the safety module is configured to operate according to the second operational mode.

In Example 68, the safety device of any one of Examples 64 to 67, wherein the artificial neural network is configured to detect the anomaly according to a predetermined schedule.

In Example 69, the safety device of any one of Examples 64 to 68, wherein the anomaly detector processor is configured to detect the anomaly by implementing one or more rule-based operations.

In Example 70, the safety device of any one of Examples 64 to 69, wherein the anomaly detector further includes an artificial neural network, and wherein the anomaly detector processor is configured to detect the anomaly by implementing the artificial neural network.

In Example 71, the safety device of any one of Examples 64 to 70, wherein the output of the function module includes one or more control outputs of the function module.

In Example 72, the safety device of Example 71, wherein the one or more control outputs of the function module include at least one of a processing delay of the robot, a temperature of a component of the robot, an image sensor output of the robot, an image processing output of the robot, a distance measured using a proximity sensor, a light intensity using a light sensor, a volume measured using a microphone, or a velocity or acceleration measured using a sensor of the robot.

In Example 73, the safety device of any one of Examples 64 to 72, wherein the output of the function module includes one or more navigation outputs of the function module.

In Example 74, the safety device of Example 73, wherein the one or more navigation outputs of the function module include at least one of a torque of an actuator of the robot, a velocity of the robot, an acceleration of the robot, or an angle of movement of the robot compared to a reference point, a position of the robot.

In Example 75, the safety device of any one of Examples 57 to 74, wherein the safety module is configured to operate according to the first operational mode if the difference between the response and the expected response is within the predetermined range, and if the anomaly detector detects no anomaly.

In Example 76, the safety device of Example 75, wherein the safety module is configured to operate according to second operational mode if the difference between the response and the expected response is outside the predetermined range, or if the anomaly detector detects no anomaly.

In Example 77, the safety device of any one of Examples 57 to 76, wherein the safety device further includes a server, configured to receive data from, and to send data to, the safety module.

In Example 78, the safety device of Example 77, wherein the server includes a stimulus-response library, the stimulus-response library including a plurality of stimulus-response pairs for the stimulus-response tester; wherein the server is configured to select one or more of the stimulus-response pairs for testing by the stimulus-response tester; and wherein the server is configured to send the selected one or more of the stimulus-response pairs to the safety module.

In Example 79, the safety device of Example 77 or 78, wherein the robot is configured to send an activity log to the safety module, the activity log representing past activities of the function module; wherein safety module is configured to send activity information representing the one or more activity logs to the server; wherein the server includes a predictive scheduler, the predictive schedule being configured to generate the stimulus-response testing schedule, wherein the stimulus-response testing schedule represents predicted periods of inactivity of the function module based on the activity information.

In Example 80, the safety device of any one of Examples 77 to 79, wherein the robot is a first robot and the function module of the first robot is a first function module, and wherein the safety device further includes a second robot; wherein the second robot includes a second function module; and wherein the server is configured to receive data representing a data output of the first function module and an output of the second function module, and wherein the sever is configured to perform a federated learning operation using the data representing the data output of the first function module and the output of the second function module.

In Example 81, the safety device of any one of Examples 77 to 80, wherein the safety module is a first safety module; wherein the safety device further includes a second safety module; and wherein the server is configured to receive data representing a data output of the safety module and an output of the second safety module, and wherein the sever is configured to perform a federated learning operation using the data representing the data output of the first safety module and the output of the second safety module.

In Example 82, the safety device of any one of Examples 77 to 81, wherein, operating according to the second operational mode further includes sending the stimulus and/or the response to the server; wherein the server further includes an artificial neural network, configured to perform a machine learning operation using the stimulus and/or the response.

In Example 83, the safety device of any one of Examples 77 to 82, wherein, operating according to the second operational mode further includes the server generating a virtual stimulus that is sent to one or more robots; receiving a response to the virtual stimulus, and generating a confidence score based on the response.

In Example 84, the safety device of any one of Examples 77 to 83, wherein the safety module is configured to send the response to the server, and wherein the server is configured to determine the difference between the response and the expected response.

In Example 85, the safety device of any one of Examples 57 to 84, wherein at least one of the response representing the processed stimulus received from the function module, the stimulus sent by the stimulus-response tester to the robot for processing by the function module; the anomaly detector input received by the anomaly detector processor from the function module; the one or more of the stimulus-response pairs sent from the server to the safety module; or the activity log sent from the robot to the safety module are encoded as part of a distributed public ledger.

In Example 86, the safety device of Example 85, wherein the distributed public ledger is a blockchain.

In Example 87, the safety device of any one of Examples 57 to 86, wherein the robot is a first robot; further including a second robot; and wherein the first robot is configured to transmit a message to the second robot.

In Example 88, the safety device of Example 87, wherein the message represents anomalous data detected by the first robot.

In Example 89, the safety device of Example 87 or 88, wherein the transmission of the message is a broadcast of the message.

In Example 90, the safety device of any one of Examples 57 to 89, further including a safety learning module, wherein the safety learning module is configured to receive safety data representing at least one of sensor data of one or more robots, data information from a server, or information from the tuning module and based on the safety data, generate and send a corrective action for implementation in one or more robots.

In Example 91, the safety device of Example 90, wherein the safety learning module is configured to generate the corrective action using reinforcement learning.

In Example 92, a safety device, including: a data augmentation module, configured to: receive operational data from one or more sources, the operational data representing operations of a robot and including at least sensor data from one or more sensors of the robot; and augment the sensor data according to one or more data augmentation techniques; and a virtual sensor, configured to determine a safety factor for the robot based on at least the augmented data; and if the safety factor is within a predetermined range, operate according to a first operational mode; and if the safety factor is outside of the predetermined range, operate according to a second operational mode; wherein operating according to the second operational mode includes determining a corrective action for the robot; and send a signal representing an instruction to perform the corrective action to the robot.

In Example 93, the safety device of Example 92, wherein the data augmentation module is further configured to receive operational log data, representing actions of one or more robots; and wherein the data augmentation module is further configured to augment the operational log data; wherein the operational data includes the augmented operational log data.

In Example 94, the safety device of any one of Examples 92 to 93, further including data tuner, configured to execute one or more recurrent learning procedures using the signal representing the instruction to the robot to perform the corrective action and data representing one or more outputs of the robot.

In Example 95, the safety device of Example 94, wherein the instruction to perform the corrective action is an instruction at a first time period, and wherein the data representing one or more outputs of the robot is from a second time period, after the first time period.

In Example 96, the safety device of Example 95, wherein the virtual sensor is configured to determine based on the data of the first time period and the second time period whether the instruction resulted in an increased safety factor.

In Example 97, the safety device of any one of Examples 94 to 96, wherein the executing the one or more recurrent learning procedures includes executing a reward function.

In Example 98, the safety device of any one of Examples 94 to 97, wherein the data tuner is further configured to determine a subset of sensor data from the robot and wherein the data tuner executing the one or more recurrent learning procedures includes executing the one or more recurrent learning procedures based on the subset of data.

In Example 99, a non-transitory computer readable medium, including instructions which, if executed by a processor, cause the processor to: send a stimulus of a stimulus-response pair to a robot, the stimulus-response pair including a stimulus and an expected response to the stimulus; receive from the robot a response to the stimulus; wherein if a difference between the response and an expected response is within a predetermined range, operating according to a first operational mode; and if the difference between the response and the expected response is outside of the predetermined range, operate according to a second operational mode.

In Example 100, the non-transitory computer readable medium of Example 99, wherein the instructions are further configured to cause the processor to determine the difference between the response and the expected response.

In Example 101, the non-transitory computer readable medium of Example 99 or 100, wherein sending the stimulus includes sending an instruction including one or more instruction bits representing the stimulus, and one or more stimulus identification bits, the stimulus identification bits indicating that the instruction bits are a stimulus for stimulus-response testing.

In Example 102, the non-transitory computer readable medium of Example 101, wherein the robot is configured to recognize the one or more stimulus identification bits, and in response to the one or more stimulus identification bits, disable one or more actuators such that the stimulus is not physically performed.

In Example 103, the non-transitory computer readable medium of any one of Examples 100 to 102, wherein the instructions are further configured to cause the processor to send a stimulus to the robot according to a stimulus-response testing schedule, wherein the stimulus-response testing schedule represents predicted periods of inactivity of the function module.

In Example 104, the non-transitory computer readable medium of any one of Examples 100 to 103, wherein the difference between the response and the expected response is a confidence score of the response, and further including determining the confidence score.

In Example 105, the non-transitory computer readable medium of any one of Examples 99 to 104, wherein the instructions are further configured to cause the processor to: receive anomaly detector input representing an output of a robot, and detect an anomaly in the anomaly detector input; wherein if the anomaly detector detects no anomaly, the processor is configured to operate according to the first operational mode; and if the anomaly detector detects an anomaly, the processor is configured to operate according to the second operational mode.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all Examples included herein.

What is claimed is:

1. A safety system, comprising:
a robot comprising,
a function module, configured to perform a robot function; and
a safety module, configured to communicate with the robot, the safety module comprising:
a stimulus-response tester, configured to:
send a stimulus of a stimulus-response pair, comprising a stimulus and an expected response to the stimulus, to the robot for processing by the function module; and
receive from the function module a response representing the processed stimulus;
wherein if a difference between the response and the expected response is within a predetermined range, the safety module is configured to operate according to a first operational mode; and
if the difference between the response and the expected response is outside of the predetermined range, the safety module is configured to operate according to a second operational mode.

2. The safety system of claim 1, wherein sending the stimulus to the robot comprises sending an instruction comprising one or more instruction bits representing the stimulus, and one or more stimulus identification bits, the stimulus identification bits indicating that the instruction bits are a stimulus for stimulus-response testing.

3. The safety system of claim 2, wherein the robot is configured to recognize the one or more stimulus identification bits, and in response to the one or more stimulus identification bits, disable one or more actuators such that the stimulus is not physically performed.

4. The safety system of claim 3, wherein the stimulus-response tester is further configured to send a stimulus to the robot according to a stimulus-response testing schedule; wherein the stimulus-response testing schedule represents predicted periods of inactivity of the function module.

5. The safety system of claim 1, wherein the safety module further comprises an anomaly detector, comprising:
an anomaly detector processor, configured to receive anomaly detector input, representing an output of the function module, and to detect an anomaly in the anomaly detector input;
wherein if the anomaly detector detects no anomaly, the safety module is configured to operate according to the first operational mode; and
if the anomaly detector detects an anomaly, the safety module is configured to operate according to the second operational mode.

6. The safety system of claim 5, wherein the function module is a first function module, and wherein the robot further comprises a second function module; and wherein the anomaly detector processor is configured to receive anomaly detector input, representing an output of the first function module and the second function module, and to detect an anomaly in the anomaly detector input;
wherein if the anomaly detector detects no anomaly, the safety module is configured to operate according to the first operational mode; and
if the anomaly detector detects an anomaly, the safety module is configured to operate according to the second operational mode.

7. The safety system of claim 6, wherein the robot is a first robot and the function module of the first robot is a first function module, and wherein the safety system further comprises a second robot; wherein the second robot comprises a second function module; and
wherein the anomaly detector processor is configured to receive anomaly detector input, representing an output of the first function module and an output of the second function module, and to detect an anomaly in the anomaly detector input;
wherein if the anomaly detector detects no anomaly, the safety module is configured to operate according to the first operational mode; and
if the anomaly detector detects an anomaly, the safety module is configured to operate according to the second operational mode.

8. The safety system of claim 1, wherein the output of the function module comprises one or more control outputs of the function module, wherein the one or more control outputs of the function module comprise at least one of a processing delay of the robot, a temperature of a component of the robot, an image sensor output of the robot, an image processing output of the robot, a distance measured using a proximity sensor, a light intensity using a light sensor, a volume measured using a microphone, or a velocity or acceleration measured using a sensor of the robot.

9. The safety system of claim 1, wherein the output of the function module comprises one or more navigation outputs of the function module, wherein the one or more navigation outputs of the function module comprise at least one of a torque of an actuator of the robot, a velocity of the robot, an acceleration of the robot, an angle of movement of the robot compared to a reference point, or a position of the robot.

10. The safety system of claim 1, wherein the safety system further comprises a server, configured to receive data from, and to send data to, the safety module;
wherein the server comprises a stimulus-response library, the stimulus-response library comprising a plurality of stimulus-response pairs for the stimulus-response tester;
wherein the server is configured to select one or more of the stimulus-response pairs for testing by the stimulus-response tester; and
wherein the server is configured to send the selected one or more of the stimulus-response pairs to the safety module.

11. The safety system of claim 10, wherein the robot is configured to send an activity log to the safety module, the activity log representing past activities of the function module;
wherein safety module is configured to send activity information representing the one or more activity logs to the server; and
wherein the server comprises a predictive scheduler, the predictive schedule being configured to generate the stimulus-response testing schedule, wherein the stimulus-response testing schedule represents predicted periods of inactivity of the function module based on the activity information.

12. The safety system of claim 11, wherein the robot is a first robot and the function module of the first robot is a first function module, and wherein the safety system further comprises a second robot;
wherein the second robot comprises a second function module; and
wherein the server is configured to receive data representing a data output of the first function module and an output of the second function module, and wherein the sever is configured to perform a federated learning operation using the data representing the data output of the first function module and the output of the second function module.

13. The safety system of claim 12, wherein the safety module is a first safety module;
wherein the safety system further comprises a second safety module; and
wherein the server is configured to receive data representing a data output of the first safety module and an output of the second safety module, and wherein the sever is configured to perform a federated learning operation using the data representing the data output of the first safety module and the output of the second safety module.

14. The safety system of claim 13, wherein, operating according to the second operational mode further comprises sending the stimulus and/or the response to the server; wherein the server further comprises an artificial neural network, configured to perform a machine learning operation using the stimulus and/or the response; or wherein, operating according to the second operational mode further comprises the server generating a virtual stimulus that is sent to one or more robots; receiving a response to the virtual stimulus, and generating a confidence score based on the response.

15. The safety system of claim 1, wherein at least one of the response representing the processed stimulus received from the function module; the stimulus sent by the stimulus-response tester to the robot for processing by the function module; the anomaly detector input received by the anomaly detector processor from the function module; the one or more of the stimulus-response pairs sent from the server to the safety module; or the activity log sent from the robot to the safety module are encoded as part of a distributed public ledger.

16. The safety system of claim 1, wherein the robot is a first robot; further comprising a second robot; and wherein the first robot is configured to transmit a message to the second robot; wherein the message represents anomalous data detected by the first robot; and wherein the transmission of the message is a broadcast of the message.

17. The safety system of claim 1, further comprising a safety learning module, wherein the safety learning module is configured to receive at least one of safety data representing sensor data of one or more robots, data information from a server, or information from the tuning module, and based on the safety data, generate and send a corrective action for implementation in one or more robots; wherein the safety learning module is configured to generate the corrective action using reinforcement learning.

18. A safety system, comprising:
a data augmentation module, configured to:
receive operational data from one or more sources, the operational data representing operations of a robot and comprising sensor data from one or more sensors of the robot; and
augment the sensor data according to one or more data augmentation techniques; and
a virtual sensor, configured to determine a safety factor for the robot, based on at least the augmented data;
wherein if the safety factor is within a predetermined range, the safety system is configured to operate according to a first operational mode; and
if the safety factor is outside of the predetermined range, the safety system is configured to operate according to a second operational mode;
wherein operating according to the second operational mode comprises determining a corrective action for the robot and sending a signal representing an instruction to perform the corrective action to the robot.

19. The safety system of claim 18, wherein the data augmentation module is further configured to receive operational log data, representing actions of one or more robots; and
wherein the data augmentation module is further configured to augment the operational log data;
wherein the operational data comprises the augmented operational log data.

20. The safety system of claim 19, further comprising a data tuner, wherein the data tuner is configured to execute one or more recurrent learning procedures using:
the signal representing the instruction to the robot to perform the corrective action; and
data representing one or more outputs of the robot.

21. The safety system of claim 20, wherein the instruction to perform the corrective action is an instruction at a first time period, and wherein the data representing one or more outputs of the robot is from a second time period, after the first time period, wherein the virtual sensor is configured to determine based on the data of the first time period and the second time period whether the instruction resulted in an increased safety factor.

22. The safety system of claim 21, wherein the executing the one or more recurrent learning procedures comprises executing a reward function.

23. The safety system of claim 22, wherein the data tuner is further configured to determine a subset of sensor data from the robot and wherein the data tuner executing the one or more recurrent learning procedures comprises executing the one or more recurrent learning procedures based on the subset of data.

24. A safety device, comprising:
a safety module, comprising:
a stimulus-response tester, configured to:
send a stimulus of a stimulus-response pair, comprising a stimulus and an expected response to the stimulus, to a robot for processing by the function module; and
receive from the function module a response representing the processed stimulus;
wherein if a difference between the response and the expected response is within a predetermined range, the safety module is configured to operate according to a first operational mode; and
if the difference between the response and the expected response is outside of predetermined range, the safety module is configured to operate according to a second operational mode.
